(19) United States
(12) Patent Application Publication
(10) Pub. No.: US 2005/0147115 A1
(43) Pub. Date: Jul. 7, 2005

(54) SDMA training operations

(76) Inventors: Qinghua Li, Sunnyvale, CA (US); Minnie Ho, Los Altos, CA (US); Adrian P. Stephens, Cambridge (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/745,891

(22) Filed: Dec. 24, 2003

(51) Int. Cl. H04L 12/403

(52) U.S. Cl. 370/449

(57) ABSTRACT

During a training phase in a network using spatial division multiple access (SDMA) techniques, frame types that trigger network allocation vectors may be used in the training phase to prevent unwanted devices from transmitting during the training phase.

### BACKGROUND

To address the problem of ever-increasing bandwidth requirements that are placed on wireless data communications systems, various techniques are being developed to allow multiple devices to communicate with a single base station by sharing a single channel. In one such technique, a base station may transmit or receive separate signals to or from multiple mobile devices at the same time on the same frequency, provided the mobile devices are located in sufficiently different directions from the base station. For transmission from the base station, different signals may be simultaneously transmitted from each of separate spaced-apart antennas so that the combined transmissions are directional, i.e., the signal intended for each mobile device may be relatively strong in the direction of that mobile device and relatively weak in other directions. In a similar manner, the base station may receive the combined signals from multiple independent mobile devices at the same time on the same frequency through each of separate spaced-apart antennas, and separate the combined received signals from the multiple antennas into the separate signals from each mobile device through appropriate signal processing so that the reception is directional.

Under currently developing specifications, such as IEEE 802.11 (IEEE is the acronym for the Institute of Electrical and Electronic Engineers, 3 Park Avenue, 17th floor, New York, N.Y.), the parameters needed to control the directional nature of both transmissions and receptions may vary depending on various factors, including the direction of each mobile device from the base station. Since these factors may not be known in advance of operation, and may even change during operation, they may not be programmed into the system in advance.

### BRIEF DESCRIPTION OF THE DRAWINGS

The invention may be understood by referring to the following description and accompanying drawings that are used to illustrate embodiments of the invention. In the drawings:

FIG. 1 shows a diagram of a communications network for a training operation, according to an embodiment of the invention.

FIGS. 2 and 3 show timing diagrams of a training operations, according to some embodiments of the invention.

FIGS. 4, 5 and 6 show formats of various frame types, according to some embodiments of the invention.

FIG. 7 shows a flow diagram of a method of operation in a base station, according to an embodiment of the invention.

FIG. 8 shows a flow diagram of a method of operation in a mobile device, according to an embodiment of the invention.

FIG. 9 shows a block diagram of a base station, according to an embodiment of the invention.

FIG. 10 shows a block diagram of a mobile device, according to an embodiment of the invention.

### DETAILED DESCRIPTION OF THE INVENTION

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

In keeping with common industry terminology, the terms “base station”, “access point”, and “AP” may be used interchangeably herein to describe an electronic device that may communicate wirelessly and substantially simultaneously with multiple other electronic devices, while the terms “mobile device” and “STA” may be used interchangeably to describe any of those multiple other electronic devices, which may have the capability to be moved and still communicate, though movement is not a requirement. However, the scope of the invention is not limited to devices that are labeled with those terms. Similarly, the terms “spatial division multiple access” and SDMA may be used interchangeably. As used herein, these terms are intended to encompass any communication technique in which different signals may be transmitted by different antennas substantially simultaneously from the same device such that the combined transmitted signals result in different signals intended for different devices being transmitted substantially in different directions on the same frequency, and/or techniques in which different signals may be received substantially simultaneously through multiple antennas on the same frequency from different devices in different directions and the different signals may be separated from each other through suitable processing. The term “same frequency”, as used herein, may include slight variations in the exact frequency due to such things as bandwidth tolerance, Doppler shift adaptations, parameter drift, etc. Two or more transmissions to different devices are considered substantially simultaneous if at least a portion of each transmission to the different devices occurs at the same time, but does not imply that the different transmissions must start and/or end at the same time, although they may. Similarly, two or more receptions from different devices are considered substantially simultaneous if at least a portion of each reception from the different devices occurs at the same time, but does not imply that the different transmissions must start and/or end at the same time, although they may. Variations of the words represented by the term SDMA may sometimes be used by others, such as but not limited to substituting “space” for “spatial”, or “diversity” for “division”. The scope of various embodiments of the invention is intended to encompass such differences in nomenclature.

Various embodiments of the invention may use a network allocation vector to prevent other devices from interfering with the training operation of a particular mobile device. In some embodiments, request-to-send and/or clear-to-send frames may trigger other devices to withhold transmissions for a specified amount of time during a training sequence. In other embodiments specific types of data frames may be used for the same purpose.

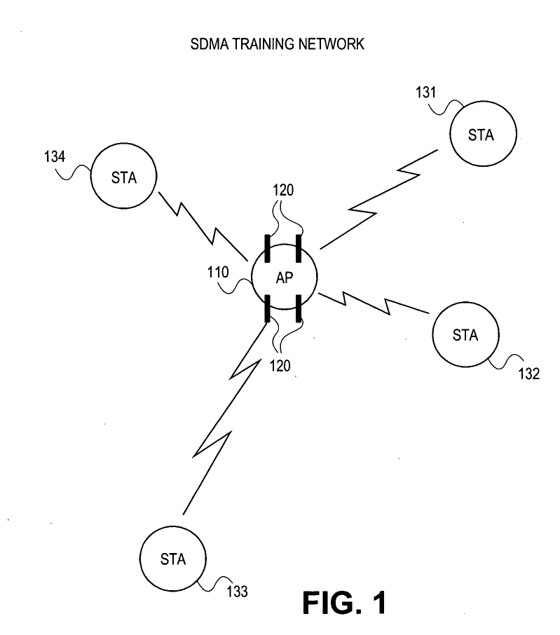

FIG. 1 shows a diagram of a communications network for SDMA training, according to an embodiment of the invention. The illustrated embodiment of a communications network shows an AP 110 that may communicate with multiple STAs 131-134 located in different directions from the AP. Using the techniques described herein, the AP 110 may employ an SDMA training phase to determine the parameters needed to transmit different signals to each of multiple ones of the STAs substantially simultaneously on the same frequency, and to receive different signals from each of multiple ones of the STAs substantially simultaneously on the same frequency, and may then use those parameters to enable such substantially simultaneous communications.

Although AP 110 is shown with four antennas 120 to communicate wirelessly with up to four STAs at a time using SDMA techniques, other embodiments may have other arrangements (e.g., AP 110 may have two, three, or more than four antennas). Each STA may have at least one antenna to communicate wirelessly with the AP 110. In some embodiments the STA antenna(s) may be adapted to operate omnidirectionally, but in other embodiments the STA antenna(s) may be adapted to operate directionally. In some embodiments the STAs may be in fixed locations, but in other embodiments at least some of the STAs may be moving during and/or between communications sequences. In some embodiments the AP may be in a fixed location, but in other embodiments the AP may be moving during and/or between communications sequences.

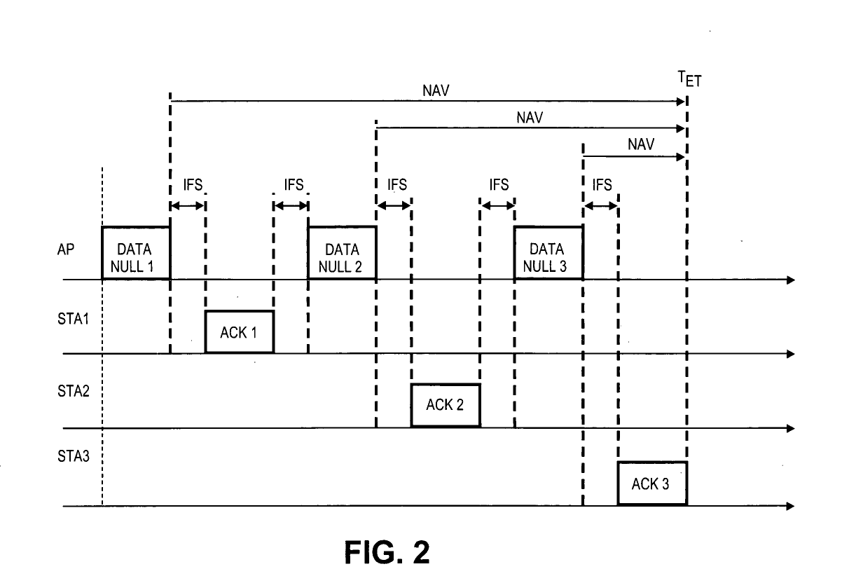

FIG. 2 shows a timing diagram of an example of a training phase, according to an embodiment of the invention. In FIG. 2, transmissions from a base station are on the line indicated as AP, while transmissions from three mobile devices are on the lines indicated as STA1, STA2, and STA3, respectively. Although three STAs are shown in this example, other quantities of STAs may be used in a training operation, following the principals described herein. In FIG. 2, the number 1, 2 or 3 at the end of a label (e.g., DATA NULL 1, ACK3, etc.) may indicate a transmission to or from STA 1, 2, or 3, respectively. In the illustrated embodiment, the AP is shown transmitting a data null frame (DATA NULL) to STA1 as a training poll. In some embodiments, a data null frame may be a data frame with zero bytes in the data field, although other embodiments may use a different format (e.g., the data field may consist of null characters, etc.). STA1 may then respond with an acknowledgment (ACK) as a training response. The AP may then process the received ACK signal to derive parameters for SDMA operations to be used with STA1. Following the exchange between the AP and STA1, the AP may send a DATA NULL to STA 2 as a training poll, to which STA2 may respond with an ACK as a training response. The AP may then process the ACK 2 signal to derive parameters for SDMA operations to be used with STA2. A similar exchange may then take place between the AP and STA3. Some or all of these transmissions may be omnidirectional from the transmitting device, although various embodiments are not limited in this respect.

During a training response, devices other than the responding STA should refrain from transmitting, as their signals may interfere with the signal received at the antennas of the AP from the responding STA, and thereby may cause faulty parameters to be derived. Each data null frame may include a field containing a duration indicator, defining the remaining time left until the time T_{ET} at end of this sequence of training exchanges. In some embodiments the duration indicator may be expressed in microseconds, but various embodiments of the invention are not limited in this respect. During the time specified by the duration indicator, shown in the drawings as a network allocation vector (NAV), all STAs except the one addressed in the poll that receive the data null frame (including those not shown and not in the training sequence but operating on the same frequency) may enter a self-imposed period during which the STAs will not initiate any transmissions, except to send an ACK in response to a poll from the AP. Thus, STA2 may acknowledge the poll DATA NULL 2, STA3 may acknowledge the poll DATA NULL 3, but these and other STAs (except for STA1 in this example) should not otherwise transmit during the indicated time. In the illustrated example, no NAV was operable at the time the DATA NULL 1 poll was received, and STA1 may therefore answer with other types of responses if requested to do so by the AP. In the illustrated example however, STA1 was only requested to respond with an ACK.

The AP may calculate the duration of the NAV before sending the DATA NULL frame, based on the transmissions and responses the AP intends to occur during the indicated operations. DATA NULL 2 may contain a similar NAV indicator, with a smaller value to account for the fact that the time T_{ET} is closer at the time DATA NULL 2 is transmitted. DATA NULL 3 may also contain a NAV, defining the time until the same end point T_{ET}. For some STAs, the different NAVs contained in the different DATA NULLs may be redundant, since they define the same end point. However, some STAs may initially be in a sleep state or otherwise unable to receive the initial DATA NULL, and therefore will need to receive a later NAV to know to maintain silence during the training period. STAs that do receive the earlier DATA NULLs may also use later DATA NULLs to recalibrate their NAV period, though various embodiments of the invention are not limited in this respect.

An interframe space (IFS) is shown between successive transmissions from difference devices. An IFS may be a defined time period during which no transmission is intended, although the invention is not limited in this respect. Various embodiments may use such time intervals in all, some, or none of the indicated places. The IFSs may have uniform duration, or may have different durations according to various criteria. These time intervals may serve various purposes, for example: 1) to allow for differences in the timing of the AP and various STAs, 2) to allow a time for any needed processing between receptions and transmissions, 3) to allow time for a transceiver to switch between transmit and receive modes, 4) etc.

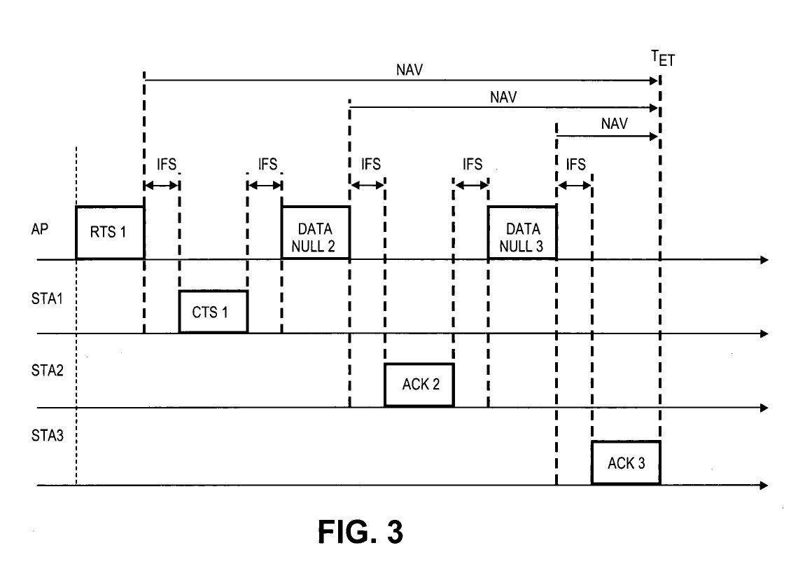

FIG. 3 shows a timing diagram similar to FIG. 2, except that the initial training poll is shown as a request-to-send (RTS), and the initial training response is shown as a clear-to-send (CTS). The RTS may also contain a duration field containing a NAV value. As previously described, the non-addressed STAs that receive the RTS may refrain from transmitting during the indicated time, except for ACKs in response to polls from the AP. The CTS may also contain a duration field that specifies a NAV value indicating the time until time T_{ET}. STAs that hear the CTS sent to the AP may establish (or recalibrate) a NAV from the CTS duration field, in a manner similar to that previously described. In some embodiments a CTS may be sent in response to an RTS only if the addressed STA does not already have an active NAV, thus the RTS/CTS exchange may be limited to the first exchange in the sequence because the CTS would not be available in the later exchanges due to the active NAV.

Although RTS, CTS, ACK, and data null frames may have other uses in other applications, they may be used for SDMA training operations in the manner described herein. In some operations, the use of these frames in SDMA training operations may be solely the province of the AP, i.e., STAs may respond as indicated without knowing whether their responses will be used for SDMA training or not, while the AP will process the received responses in a manner prescribed for SDMA training.

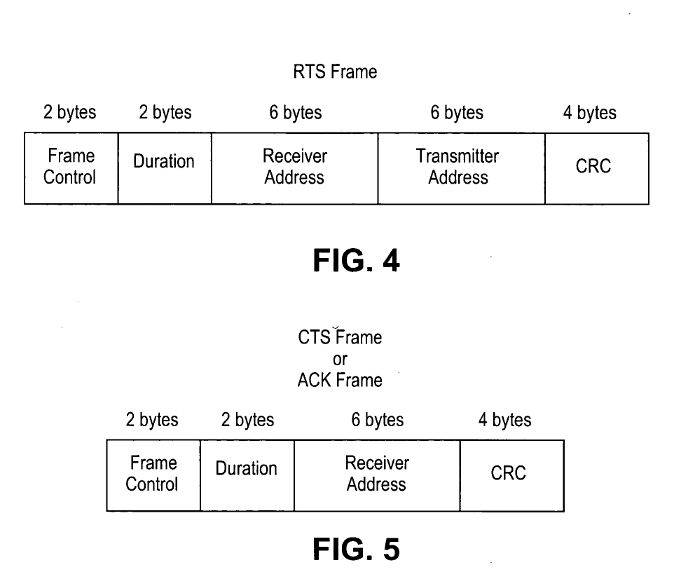

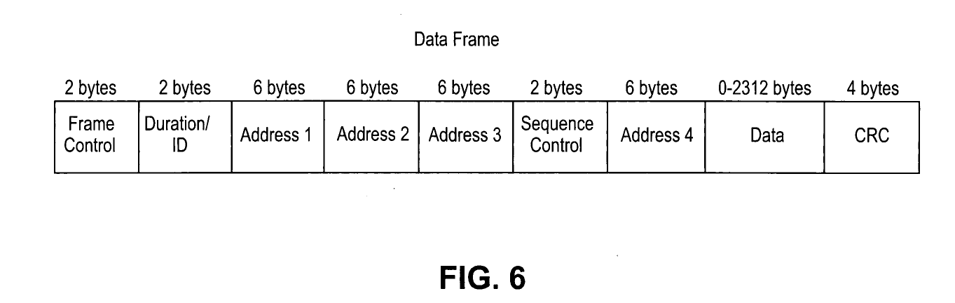

FIGS. 4, 5 and 6 show formats for various types of frames, according to various embodiments of the invention. FIG. 4 shows a format for an RTS frame, FIG. 5 shows a format for a CTS and/or an ACK frame, and FIG. 6 shows a format for a data frame (a null data frame may have 0 bytes in the data field), although various embodiments of the invention are not limited to the formats shown. The contents of the Frame Control field in each frame may specify which type of frame it is, as well as specifying other useful information. Note that each type of frame in these examples contains a Duration field, which may be used to indicate the NAV. The various Address fields may be used to specify addresses of the target and/or source devices. The CRC field may contain a check value that may be used to verify the integrity of the received frame, such as but not limited to a cyclic redundancy check (CRC) value. The Sequence Control field may contain information that helps in keeping track of multiple related transmissions, although this may or may not be useful when a data null frame is used as a training poll.

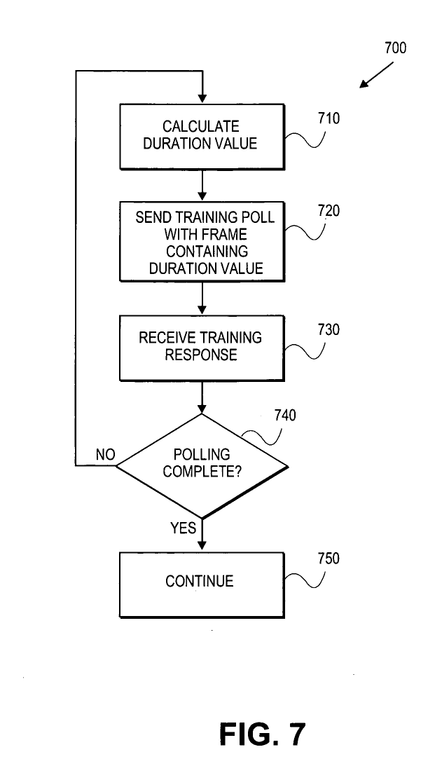

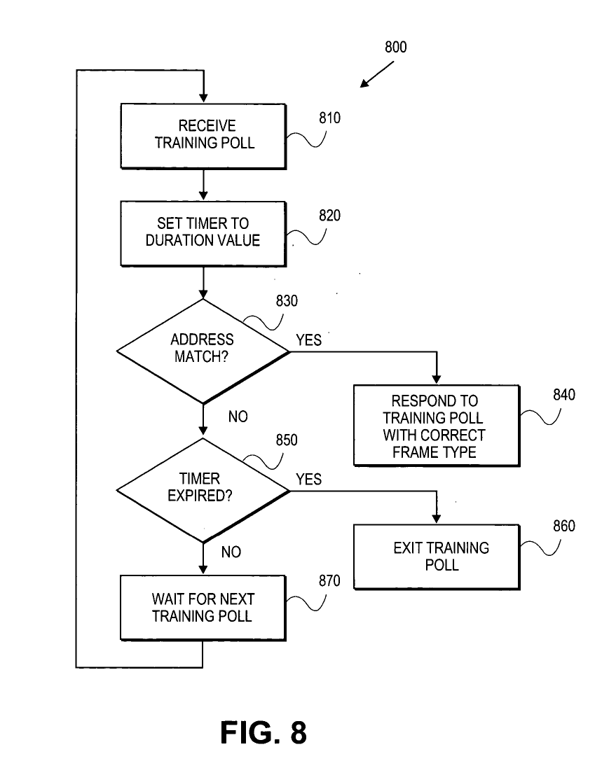

FIG. 7 shows a flow chart of a method of operation in a base station, according to an embodiment of the invention. Although the flow charts shown in FIGS. 7 and 8 only cover specific operations, other operations may also take place before, after, and/or during the operations shown. In flow chart 700, at 710 the base station may calculate a duration value (e.g., a value for a NAV) that may define the end of the current training phase. The duration value may be the sum of all expected occurrences that are to take place during the current training phase, such as the subsequent polls, the responses, and the interframe spaces, although the various embodiments of the invention are not limited in this respect. At 720 a training poll may be transmitted to a specifically-addressed mobile device, the training poll including the calculated duration value. In some embodiments the training poll may comprise an RTS frame or a data null frame, although various embodiments of the invention may not be limited in this manner. At 730 the base station may receive a training response from the addressed mobile device. If all mobile devices for the current training phase have been polled, as indicated at 740, other processing (not described) may be started or continued at 750. If there are additional mobile devices to be polled in the current training phase, processing may return to 710 for calculation of the correct duration value for the next poll. In the illustrated embodiment, a new duration value is calculated for each new training exchange after the training exchange for the previous mobile device has been completed. Other embodiments may use other techniques, such as but not limited to calculating the duration values for all polls in the training phase before polling any of the indicated mobile devices.

FIG. 8 shows a flow chart of a method of operation in a mobile device, according to an embodiment of the invention. In flow chart 800, at 810 the mobile device receives a training poll containing a duration value (such as but not limited to the duration value calculated at 710 in FIG. 7). In some embodiments the training poll may be an RTS or a data null frame, but various embodiments of the invention are not limited in this manner. At 820 a timer is set per the duration value, and begins to time the indicated timing interval, which may end at the end of the training phase. In some embodiments the value in the timer may be adjusted to begin at a particular time, rather than the exact time the timer is started. At 830 the destination address in the poll may be examined to determine if the mobile device performing these operations is the mobile device to which the poll is addressed. If it is, the mobile device may respond to the training poll at 840 by transmitting the correct frame type. In some embodiments the response may be a CTS or an ACK, but various embodiments of the invention are not limited in this manner. If the address does not match at 830, the mobile device may wait for the first of 1) expiration of the timer and 2) receipt of the next training poll, as indicated at 850, 870, and 810. If the timer expires first, indicating the training phase is over, processing may move to 860 for other processing not shown. If another training poll is received first, processing may begin again at 810, where the previous operations may be repeated. If the new training poll has a duration value, the value in the timer may be reset to the new value at 820, or alternatively block 820 may be skipped in favor of retaining the current value in the counter.

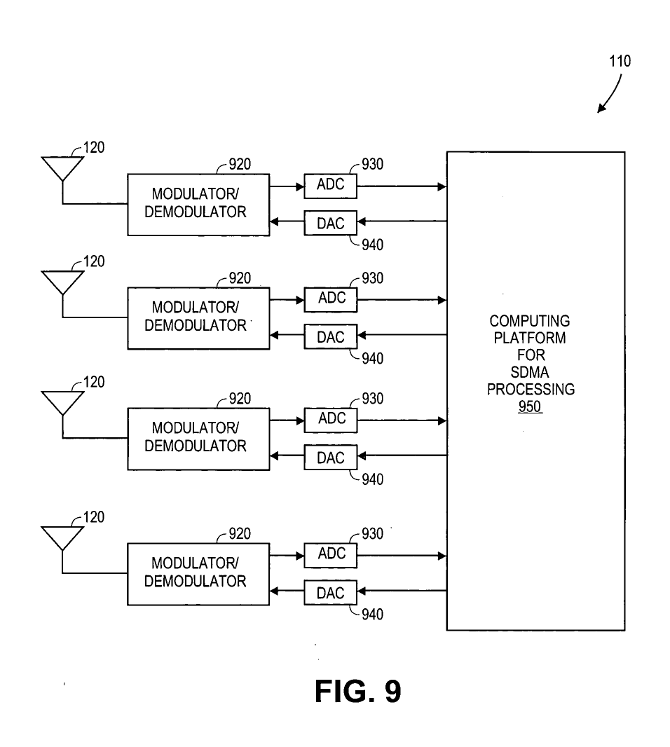

FIG. 9 shows a block diagram of a base station, according to an embodiment of the invention. Computing platform 950, which may perform processing suitable for a base station, may include one or more processors, and in some embodiments at least one of the one or more processors may be a digital signal processor (DSP). In the illustrated embodiment, AP 110 has four antennas 120, but other embodiments may have two, three, or more than four antennas. For each antenna, base station 110 may have a modulator/demodulator 920, an analog-to-digital converter (ADC) 930, and a digital-to-analog converter (DAC) 940. The combination of demodulator-ADC may convert received radio frequency signals from the antenna into digital signals suitable for processing by the computing platform 950. Similarly, the combination of DAC-modulator may convert digital signals from the computing platform 950 into radio frequency signals suitable for transmission through the antenna. Other components not shown may be included in the illustrated blocks as needed, such as but not limited to amplifiers, filters, oscillators, multiple quantities of ADCs and/or DACs where only one is shown, etc.

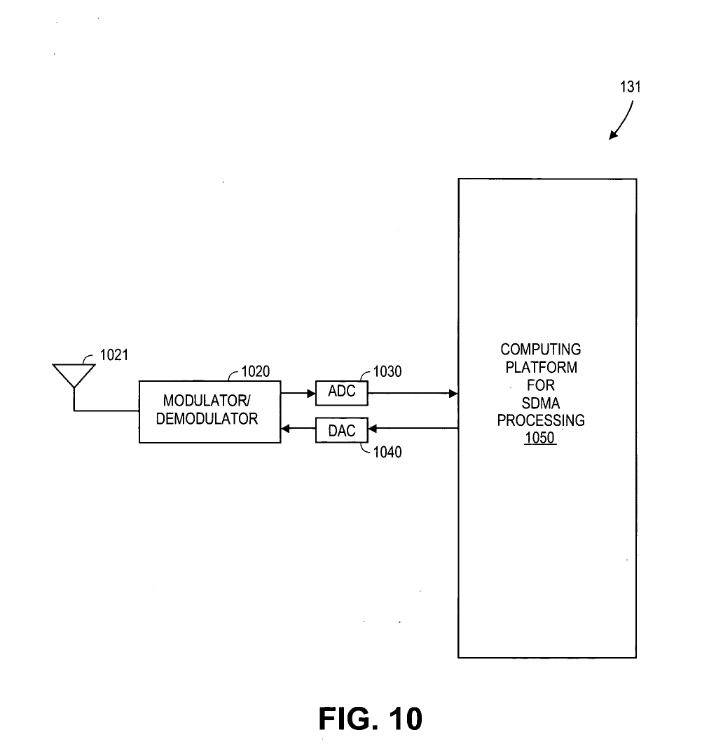

FIG. 10 shows a block diagram of a mobile device, according to an embodiment of the invention. The illustrated components of mobile device 131 may include a computing platform 1050, antenna 1021, modulator/demodulator 1020, ADC 1030, and DAC 1040 that may be functionally similar to those similarly-named components of FIG. 9, but the device of FIG. 10 is shown with a single antenna/modulator/demodulator/ADC/DAC combination, and the computing platform 1050 may perform the operations previously described for a mobile device rather than a base station, although various embodiments of the invention are not limited in these respects.

Various embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The foregoing description is intended to be illustrative and not limiting. Variations may occur to those of skill in the art. Those variations are intended to be included in the various embodiments of the invention, which are limited only by the spirit and scope of the appended claims.

1. An apparatus, comprising
a first electronic device adapted to perform:
determining a value for a network allocation vector; and
transmitting a poll to a second electronic device, the poll comprising the value.

2. The apparatus of claim 1, wherein the value is a value designating a time until completion of a training phase involving the second electronic device and a third electronic device.

3. The apparatus of claim 1, wherein said transmitting the poll comprises transmitting a request-to-send frame.

4. The apparatus of claim 1, wherein said transmitting the poll comprises transmitting a data null fame.

5. The apparatus of claim 1, further comprising receiving a response to the poll.

6. The apparatus of claim 5, further comprising processing the response to determine parameters for spatial division multiple access communications.

7. The apparatus of claim 5, wherein said receiving the response comprises receiving a clear-to-send frame.

8. The apparatus of claim 5, wherein said receiving the response comprises receiving an acknowledgement frame.

9. The apparatus of claim 5, wherein the first electronic device comprises at least four antennas to communicate with the second electronic device using spatial division multiple access techniques subsequent to said receiving the response.

10. The apparatus of claim 9, wherein the first electronic device further comprises a computing platform coupled to the at least four antennas.

11. The apparatus of claim 9, wherein the first electronic device further comprises at least four modulator/demodulators with at least one modulator/demodulator coupled between each of the at least four antennas and the computing platform.

12. A method, comprising:
transmitting a poll comprising a value indicating a duration of a training phase for spatial division multiple access communications; and
receiving a response to the poll;
wherein the duration indicates a time till an end of the training phase.

13. The method of claim 12, further comprising determining the value prior to said transmitting.

14. The method of claim 12, wherein the value indicates a network allocation vector.

15. The method of claim 12, further comprising processing the response to determine parameters for spatial division multiple access communications.

16. A machine-readable medium that provides instructions, which when executed by a processing platform, cause said processing platform to perform operations comprising:
determining a value for a time until an end of a training phase; and
transmitting a poll to an electronic device, the poll comprising the value.

17. The medium of claim 16, wherein the operation of transmitting comprises transmitting a request-to-send frame.

18. The medium of claim 17, wherein the operations further comprise an operation of receiving a clear-to-send frame responsive to the poll.

19. The medium of claim 16, where the operation of transmitting comprises transmitting a data null frame.

20. The medium of claim 19, wherein the operations further comprise an operation of receiving an acknowledgment frame responsive to the poll.
